(19) United States
(12) Patent Application Publication
(10) Pub. No.: US 2020/0005261 A1
(43) Pub. Date: Jan. 2, 2020

(54) Frictionless Automated Teller Machine

(71) Applicant: Bank of America Corporation, Charlotte, NC (US)

(72) Inventors: Ashish Arora, Issaquah, WA (US); Nathan Dent, Concord, NC (US); Michael Toth, Charlotte, NC (US); Harold Joseph Kennedy, Winter Park, FL (US); Elizabeth Anne Price, Newport, TN (US); Pavan Singaraju, Waxhaw, NC (US); Magdy Ismail, Jacksonville, FL (US); Varsha Devadas, Charlotte, NC (US)

(21) Appl. No.: 16/019,771

(22) Filed: Jun. 27, 2018

(51) Int. Cl. G06Q 20/10; G06Q 20/32; G06Q 20/40

(52) U.S. Cl. CPC G06Q 20/1085; G06Q 20/40145; G06Q 20/3223

(57) ABSTRACT

A transaction access point computing system may include an automated teller machine (ATM) or other transaction access point and an authentication server, a beacon device and, in some cases, a mobile device running a mobile application. The devices of the frictionless ATM computing system facilitates simplified user interaction with the ATM. As a user approaches the ATM, the mobile device may receive the beacon signal including a command to awaken the mobile application. After receipt, the mobile application may communicate an identifier to the authentication server, and the ATM may capture an image of the user. At the application server, the user image may be authenticated and confirmation returned to the ATM along with a unified user identifier. After confirmation of the additional identifier, the ATM may dispense a specified amount of currency.

### BACKGROUND

Aspects of the disclosure relate to interactions between computing devices of a multicomputer system. Based on detected events and event data, a client computing device may be directed by a computing platform to perform an appropriate action.

### BACKGROUND

A need has been recognized to improve and enhance capabilities of computer systems incorporating transaction action points, such as Automated Teller Machines (ATM's) to address deficiencies of traditional approaches to better satisfy user needs and/or to enhance security capabilities.

### SUMMARY

The following presents a simplified summary in order to provide a basic understanding of some aspects of the disclosure. The summary is not an extensive overview of the disclosure and is intended neither to identify key or critical elements of the disclosure nor to delineate the scope of the disclosure. The following summary merely presents some concepts of the disclosure in a simplified form as a prelude to the description below.

Aspects of the disclosure relate to systems, methods, and apparatuses for providing improved user interaction with a transaction access point, such as an ATM device. In an illustrative example, a frictionless automated teller machine (ATM) computing system may include an ATM and an authentication server, a beacon device and, in some cases, a mobile device running a mobile application. The devices of the frictionless ATM computing system facilitates simplified user interaction with the ATM. As a user approaches the ATM, the mobile device may receive the beacon signal including a command to awaken the mobile application. After receipt, the mobile application may communicate an identifier to the authentication server, and the ATM may capture an image of the user. At the application server, the user image may be authenticated and confirmation returned to the ATM with a unified user identifier. After receipt of the authentication signal from the authentication server, the ATM may dispense a specified amount of currency.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 shows an illustrative ATM computing system according to one or more aspects of the disclosure;

FIG. 2 shows an illustrative flow diagram showing a method to authorize use of an ATM by a user according to one or more aspects of the disclosure;

FIG. 3 shows an illustrative ATM computing system for pre-staged transactions according to one or more aspects of the disclosure;

FIG. 4 shows an illustrative flow diagram showing a method to authorize use of an ATM by a user to perform a pre-staged transaction according to one or more aspects of the disclosure

FIG. 5 shows an illustrative ATM computing system for authorizing use of an ATM by a user using facial and behavioral identifiers according to one or more aspects of the disclosure;

FIG. 6 shows an illustrative flow diagram showing a method to authorize use of an ATM using facial and behavioral identifiers of a user according to one or more aspects of the disclosure;

FIG. 7 shows an illustrative ATM computing system for authorizing use of an ATM using geographic information and device proximity according to one or more aspects of the disclosure;

FIG. 8 shows an illustrative flow diagram showing a method for authorizing use of an ATM using geographic information and device proximity according to one or more aspects of the disclosure;

FIG. 9 shows an illustrative for authorizing use of an ATM by a user using facial and behavioral identifiers according to one or more aspects of the disclosure;

FIG. 10 shows an illustrative flow diagram showing a method to authorize use of an ATM using facial and behavioral identifiers according to one or more aspects of the disclosure;

FIG. 11 shows an illustrative schematic diagram of a digital computing environment in which certain aspects of the present disclosure may be implemented according to one or more aspects of the disclosure; and

FIG. 12 shows an illustrative block diagram of mobile workstations and stationary workstations and servers that may be used to implement the processes and functions of certain illustrative examples according to one or more aspects of the disclosure.

### DETAILED DESCRIPTION

In the following description of the various embodiments, reference is made to the accompanying drawings, which form a part hereof, and in which is shown by way of illustration, various embodiments of the disclosure that may be practiced. It is to be understood that other embodiments may be utilized.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer-readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In many cases, automated teller machines may still utilize conventional user authentication methods, such as by requiring a user to swipe or insert a card upon which user identification information is encoded. After reading the card-stored information, the ATM may prompt the user to enter a user identifier, such as a personal identification number (PIN). Upon proper validation, the user may be granted access to one or more user accounts via a secure network connection. However, certain individuals may attempt to circumvent these security measures by capturing card information, PIN numbers and the like. While an ATM or a facility in which an ATM has been installed may include other security measures, such as cameras, financial institutions may desire to improve security measures and/or user authentication procedures to provide more security to their customers. Additionally, because current ATM access methods primarily require use of a card to access the user accounts, customer access to their own accounts may be difficult or impossible if their card has been lost or is unavailable to them. As such, a need has been recognized for improved more advanced user authentication methods and/or technology to provide greater security and convenience to the user.

In many cases, a currently existing ATM may be limited by one or more existing standards in use when installed and/or upgraded. For example, most ATMs may conform to a BASE24 standard and may be limited to the authentication parameters set by that standard. As such, the ATM may not utilize newer and/or stronger authentication options available from a financial institution's authentication server. Recent developments have increased a number of authentication options available, such as facial biometric capture at an ATM, facial biometric compare at an authentication server that may be remote or local to the ATM, geo-location capture at a mobile application (e.g., a mobile phone application) along with communication to an authentication server, a “unified” identifier including captured behavioral profile data via the mobile phone application, and the like. In some cases, one or more authentication methods may be used together to allow for increased security, accuracy of identification, and confidence that the correct user is accessing their own accounts.

In some cases, a successful integration ATM authentication and security measures with the capabilities offered by a remote authentication server may allow for a more unified authentication process across different applications and access points offered by an enterprise. Additionally, by leveraging a central authentication server, an enterprise may be able to leverage newer authentication processes faster and more easily than in the past to open the door to future opportunities and allow for stronger authentication as a need arises. Additionally, by leveraging a central authentication server, customer experience and satisfaction may be improved due to improved perceived continuity and parity between different access points, such as a mobile application interface, a website interface, an ATM interface, and the like. Advantages of the systems and methods discussed in this disclosure include increased customer experience and continuity between different applications and devices, greater usability of developed modular user authentication components allowing for rapid integration and/or sequencing during introduction to product offerings, an extensible design approach to leverage technological capabilities of different application development groups to save development costs in both time and money and allows technology to be tested and developed across different applications for added efficiencies. In some cases, different communication technologies (e.g., local networks, beacons, and the like) may be developed across product and industry sectors to standardize capabilities to link different devices (e.g., mobile applications, ATM, and banking facility networks), such as wireless coverage areas, ranges, hardware integration, device management strategies and methods, and the like.

In some cases, the illustrative examples discussed below may be used as described and/or in combination to provide improved authentication and security for users and providers of ATMs. In some cases, the illustrated examples provide streamlined authentication methodologies to lessen dependencies on current and/or legacy authentication technologies, such as those outlined by Base24. A centralized authentication server or hum may allow for one or more factors of authentication to be used and/or combined. Localized communication devices and/or networks (e.g., a beacon) may be used to provide zonal areas in which devices may communicate automatically or with user interaction. Geolocation technologies may be used in determining a unified identifier for a user and/or for devices to identify local counterparts for which interaction may be possible. Facial biometrics may be captured at a mobile device and/or at an ATM to provide increased user security and more precise authentication abilities. The facial biometrics may include a full or partial facial scan of a user that may be compared to a previously captured image (e.g., stored in a secure data store on a mobile device and/or a centralized data store at an authentication server) or with certain stored characteristics that may be derived from a full image (e.g., facial dimension characteristics, and the like). In some cases, behavioral profiles may be developed to identify certain user characteristics corresponding to use of a mobile device and/or movements, such as user swiping characteristics, login process characteristics, user gait characteristics, and the like.

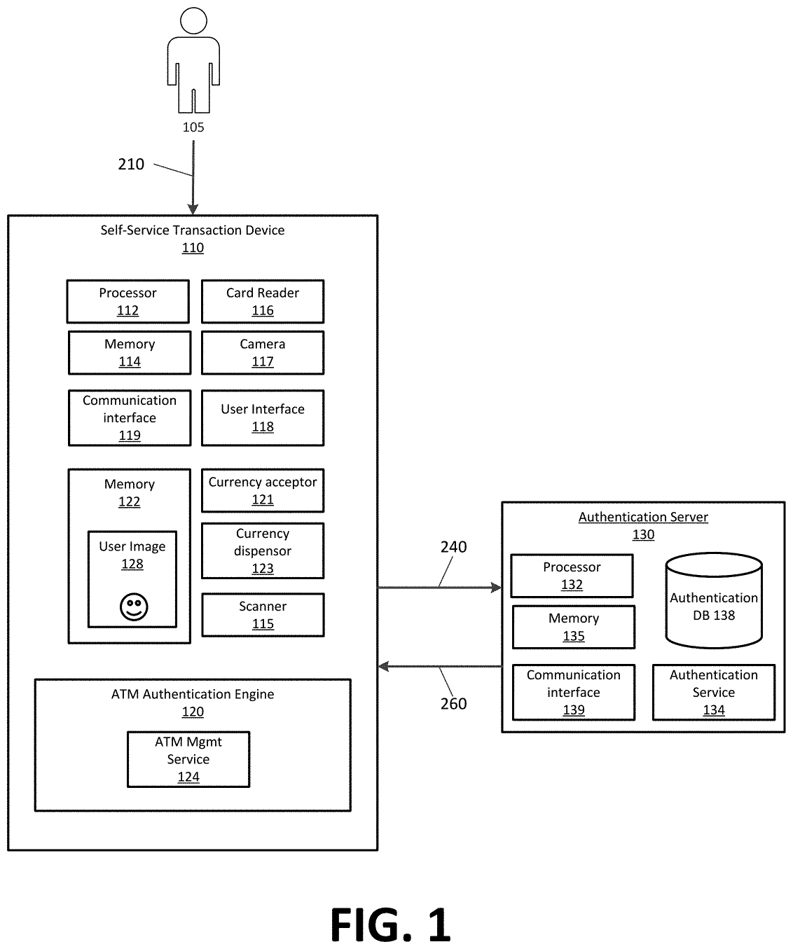

FIG. 1 shows an illustrative ATM computing system 100 according to one or more aspects of the disclosure. The illustrative ATM computing system 100 is only one illustrative example of a suitable computing environment and is not intended to suggest any limitation as to the scope of use or functionality described in this disclosure. The ATM computing system 100 should not be interpreted as having any dependency or requirement relating to any one or combination of components shown in the illustrative computing system environment. In this illustrative example, a user may interact with the ATM computing system 100 at a self-service transaction device (e.g., an ATM 100). The ATM 100 may process instructions to authenticate the user 105 over a communication link via one or more networks (e.g., a private network, a LAN connection, a WAN connection, a cellular network, the Internet, and the like) to an authentication server 130 that may be local to the ATM 110 (e.g., within a same facility) or remote to the ATM 110.

The ATM 110 may include a processor 112, one or more memory devices 114, 122, a card reader 116, an imaging device 117 (e.g., a camera), a user interface 118, a communication interface 119, a currency acceptor 121, a currency dispenser 123, a scanner 115, and the like. In some cases, the processor of the ATM 110 may process instructions stored in the memory 114 to process an ATM authentication Engine 120 to control an ATM management service 124 to, at least in part, authenticate the user 105 before allowing the user 105 to perform one or more actions on the ATM 110, such as providing access to an account held at an associated financial institution, allowing a funds deposit into the account, withdrawal of funds from the account, and/or the like.

The authentication server 130 may include a processor 132, one or more memory devices 135, and a communication interface 139. The processor 132 of the authentication server 130 may process instructions stored in one or more of the memory devices 135 to manage and/or access a data store (e.g., an authentication database 138) and/or to process one or more computing services (e.g., an authentication service) and the like.

In some cases, the processor 112 may control all or a portion of the overall operation of the ATM 110 and the associated components including the one or more memory devices 114, 122, the card reader 116, the imaging device 117, the user interface 118, the communication interface 119, the currency acceptor 121, the currency dispenser 123, the scanner 115, and the like. The ATM 110 may also include a variety of computer readable media. The computer readable media may be any available media that may be accessed by the ATM 110 and include both volatile and nonvolatile media, removable and non-removable media. By way of example, and not limitation, computer readable media may comprise a combination of computer storage media and communication media.

Computer storage media, such as one or more of the memory devices 114 and 122 may include volatile and nonvolatile, removable and non-removable media implemented in any method or technology for storage of information such as computer readable instructions, data structures, program modules or other data. The computer storage media may include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the ATM 110.

In some cases, the memory device 114 may store instructions for running one or more are applications and/or storing other information representing application data for use while the ATM 110 is operational. Additional the memory device 114 may include corresponding software applications and/or services (for example, software tasks), that may run and/or may be running on the ATM 110, such as the ATM authentication engine 120 and/or the ATM management service 124. In some cases, one or more data structures may be used to store authentication information, image data and/or associated metadata and the like. For example, the memory device 122 may be used to store data captured locally at the ATM 110, such as a user image 128 captured by the imaging device 117. In some cases, the image may be stored in a raw state or a processed state. Additionally, metadata associated with the image may be stored in the memory 122, such as date information, time information, location information, and/or user data and the like.

Computer-executable instructions may be stored within the one or more memory devices 114 and/or 122 to provide instructions to a processor for enabling computing device 101 to perform various functions, such as user authentication functions, electronic transaction functions and the like. For example, the memory device 114 may store computer-executable instructions used by the ATM 110, such as an operating system, one or more application programs, one or more services, and an associated database. Alternatively, some or all of the computer executable instructions for the ATM 110 may be embodied in hardware or firmware (not shown).

In some cases, illustrative ATM computing systems may include processing of instructions stored on forms of computer-readable media. Computer-readable media include any available media that can be accessed by a computing device, such as the ATM 110. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

The memory device 114 may include one or more program modules having instructions that when executed by the ATM 110 may cause the ATM 110 to perform one or more functions described herein.

Although not required, various aspects described herein may be embodied as a method, a data processing system, or as a computer-readable medium storing computer-executable instructions. For example, a computer-readable medium storing instructions to cause a the processor 112 to perform steps (blocks) of a method in accordance with aspects of the invention is contemplated. For example, aspects of the method steps disclosed herein may be executed on by the processor 112 of the ATM 110. Such a processor may execute computer-executable instructions stored on a computer-readable medium.

The ATM 110 includes the user interface 118 that enables the user 105 to input information into the ATM 110 and displays information to the user 105 while the user is making an ATM transaction. In addition, the ATM 100 may display non-transaction information (for example, non-targeted and targeted ads) to the user before and during an ATM transaction. The user interface may assume different forms such as a touchscreen. For example, with some embodiments, the user interface 118 may support a 32 or 40 inch display. In some cases, the user interface may include a static display device and a numeric or alphanumeric keypad, or the like. The user interface may be used by the user 105 to enter security information (for example, a personal identification number (PIN)) that is not typically visible to others to provide privacy for the user.

The ATM 110 typically includes one or more transaction handling apparatus such as the currency acceptor 121 and the currency dispenser 123 that accepts currency and the like and dispenses cash during a transaction. The scanner 115 may be used to scan items inserted into the ATM 110, such as currency and/or a written instrument representative of funds to be deposited into a user account. In some cases, the card reader 116 may be configured to receive an ATM card, a credit card, a driver's license, or the like as part of a user verification process. The card reader 116 may include a magnetic strip or chip reader to obtain the user information. In some cases, such as when a driver's license or other user identification is entered, the card reader 118 may operate in conjunction with the scanner 118 to obtain user identification information. The imaging device 117 may include a still picture camera, a video camera, and/or another imaging device (e.g., an infrared camera and the like) to capture an image of the user, the user's face and/or portions thereof. In some cases, the user interface may include one or more other devices that may be used to capture identifying information associated with the user 105 that may be used, for example, for authentication purposes. Such devices may include an eye scan device, a fingerprint sensor, and the like.

As discussed above, a financial institution associated with the ATM and/or with an account associated with the user may utilize the authentication server 130 to store user authentication information and/or process authentication requests from ATMs, mobile applications, online login requests and/or the like. The authentication server 130 may be communicatively coupled to one or more communication networks to securely communicate authentication information to and from a requesting device, such as via encrypted communications, secure communication channels or the like. In some cases, the memory 135 of the authentication server 130 may store computer-readable instructions that, when processed by the processor 132, may cause an authentication service 134 to process authentication requests from one or more connected devices. The memory 135 may also store authentication information associated with one or more users in the authentication data store 138, where the information may include user information such as the user name, contact information (e.g., a home address, a work address, a phone number, an email address, a social media account name, and the like), account information, employment information, a photo of the user, facial scan information, eye scan information, fingerprint information, behavioral information (e.g., location information, phone use information, and the like) and/or other information useful in determining proper identification of a user for authentication purposes. In some cases, the authentication information may include a data structure associated with combinations of user identifying information to form a “unified” identifier that may be used as at least a portion of a user authentication process.

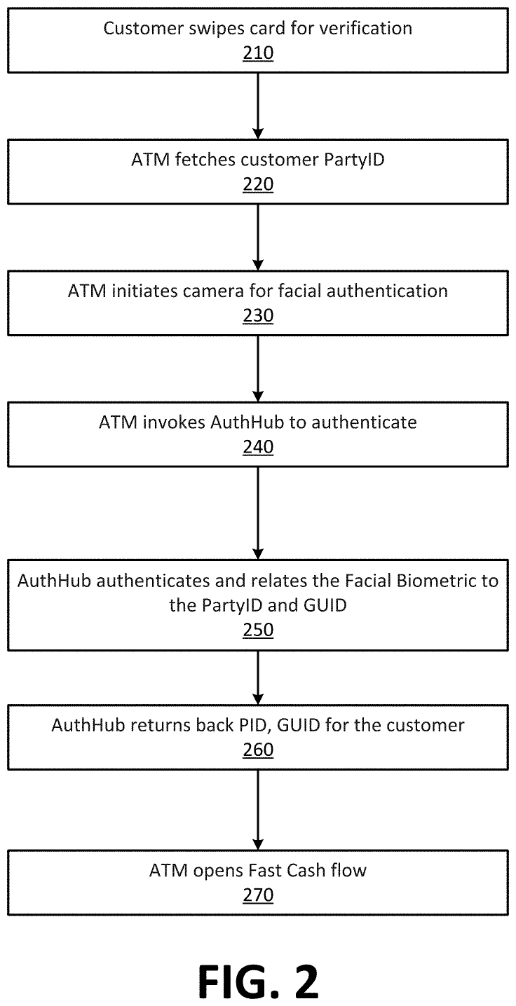

FIG. 2 shows an illustrative flow diagram showing a user authentication method 200 to authorize use of an ATM by a user according to one or more aspects of the disclosure, with several steps being shown in FIG. 1. For example, the user authentication method 200 may allow user authentication through use of a card (e.g., ATM card, credit card and/or driver's license) and one or more user characteristics (e.g., facial biometrics). While use of an ATM card and facial biometrics are discussed, other cards and/or user characteristics (e.g., finger prints, retinal scans, and/or the like) may be similarly used or combined to provide increased security and confidence in a proper user authentication.

In a first example, as shown in FIGS. 1 and 2, a user authentication methodology may provide complete authentication at the ATM 110 using a card (e.g., an ATM card) and captured facial biometrics. At 210, a user 105 may approach the ATM 110 and swipe a card at the card reader 116 for verification. At 220, the ATM 110 may fetch a customer identifier associated with the user 110, either from the captured card information and/or from a remote server based on the captured card information. In some cases, the ATM 110 may initiate the ATM management service 124 to fetch the user identifier or the ATM authentication engine 120 may invoke one or more other services to do so. At 230, the ATM 110 may initiate a camera such as the imaging device 117 to capture an image 128 of the user's face and/or at least a portion of the user's face (e.g., a “faceprint”) for use in facial authentication of the user 105. The user image 128 may be stored in local memory 122 of the ATM for comparison locally, or may be communicated wholly or in part to the authentication server 130 for comparison to stored user facial biometric data as at least a portion of the user authentication process.

At 240, the ATM 110 may invoke the authentication server (e.g., an authentication hub) to authenticate the user, such as by invoking a new or existing authentication service, such as the ATM management service 124. The ATM management service may coordinate secure and/or encrypted communication between the ATM 110 and the authentication server 130 to communicate user identification information obtained from the card data and the user image 128 to the authentication server 130 to authenticate the user 105. Communication between the ATM and the authentication server 130 may be performed over one or more communication networks, such as a WAN, a LAN, the Internet, a cellular communication network, a private network, and the like. At 250, the authentication server 130 may invoke a process instance to authenticate the user, such as the authentication service 134. The authentication service may be a unique instance associated with a particular request (e.g., a particular user transaction request) or with the ATM. In some cases, the authentication service 134 may be configured to provide authentication services to multiple ATMs at a particular location or ATMs at different geographic locations. The authentication service 134 may authenticate the user via facial biometric information and associate the user request to a particular matched user identifier (e.g., a party ID) and/or a global unique identifier (GUID) corresponding to a user matching the authenticated facial biometrics. The authentication may receive the user data and the user image 128 from the ATM and compare one or more portions of that data (e.g., a user name, a user account, a card identifier, facial biometrics identifiable from the user image 128, and the like) to user identifiers associated with the user 105 stored in the authentication data store 138.

After completion of the user authentication process, the authentication service 134 may cause the authentication server to return a matched personal identifier (PID) and GUID corresponding to the user 105 to the ATM 110. At 270, the ATM may use the returned PID and GUID to authorize a requested user transaction that may be triggered by the user via the user interface 118, such as by initiating a funds dispensing event from a user account to the user 105 via the currency dispenser 123, such as via a “fast cash flow” event process.

Advantages of the process described in FIGS. 1 and 2 include minimal interaction with the ATM by the user, such as no required entry of a PIN. Instead, a fast user experience may be initiated via a simple card swipe or insertion. However, this particular example does not provide a total hands-free experience for the user because a physical card is still required.

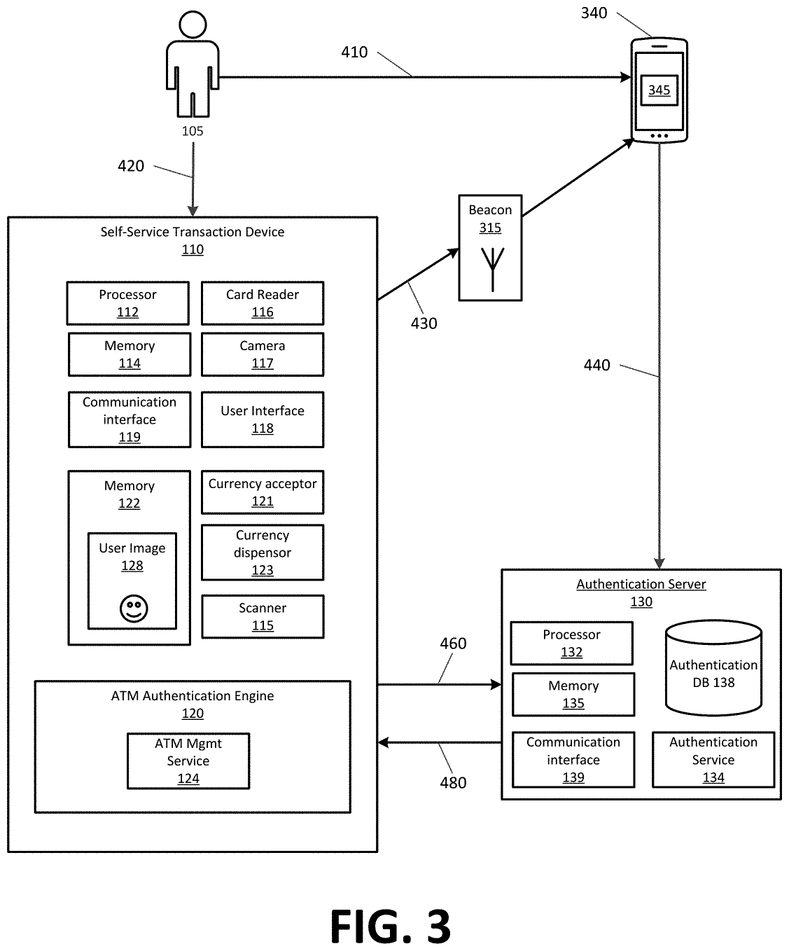

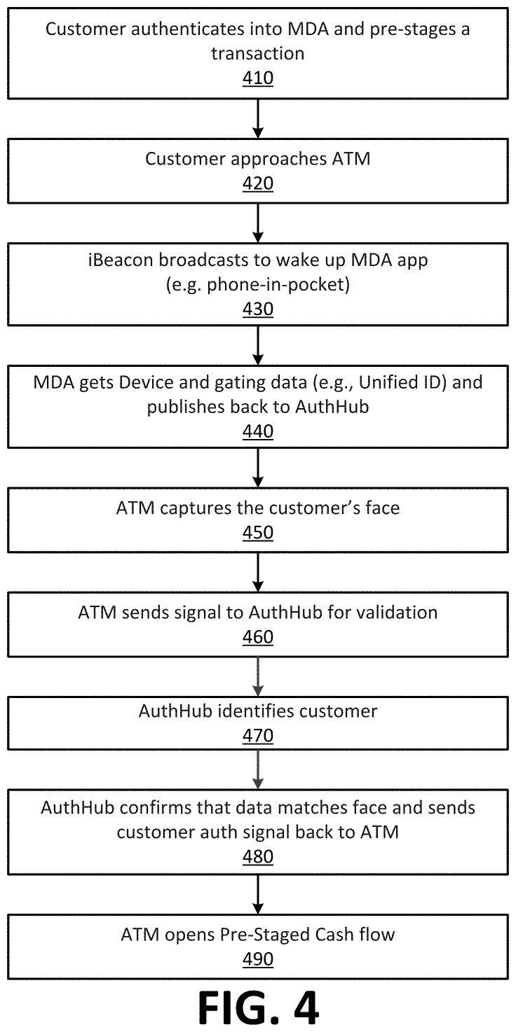

FIGS. 3 and 4 shows an illustrative ATM computing system 300 and method 400 for pre-staged transactions according to one or more aspects of the disclosure. The illustrative computing system includes similar ATM 110 and authentication server 130 components as discussed above with respect to FIGS. 1 and 2, but are not limited to such features. Additionally, the ATM computing system 300 may include a beacon 315 and a mobile device 340 associated with the user 105. The mobile device 340 may comprise a mobile phone upon which a mobile application 345 (e.g., a mobile banking application, an authentication application, and the like) is installed and running.

The beacon 315 may be associated with one or more ATMs including the ATM 110 such that the beacon 315 may be located at, within, or in close proximity to the ATM 110. The beacon 315 may transmit messages comprising beacon information over a wireless communication channel that may be received by the mobile device 340 via the mobile application 345 when the mobile device is within range of the beacon 315 and/or as the user 105 approaches the ATM 110 and is within range of the beacon 315. In an illustrative example, the beacon 315 may support a communication protocol such as BLUETOOTH® having a class with a desired range. (BLUETOOTH supports different classes including 1, 2, 3, 4 with typical ranges of 100 meters, 10 meters, 1 meter, and 0.5 meters, respectively.) Other communication protocols may also be used in addition to, or in place of another. Such communication protocols may include iBeacon, Bluetooth low energy (BLE), Eddystone, AltBeacon, GeoBeacon, and the like. In some cases, the beacon 315 may include another wireless network or communication technology to perform similar functions, such as WiFi aware, ultrasound, and the like. The beacon 315 may also comprise a so-called “nearable” device configured to communicate with other devices via the “Internet of Things.” In some cases, the beacon information may include information that may be extracted by the mobile application 345. Such beacon information may include a universally unique identifier (UUID), e.g., a 16-byte UUID that may provide unique information across all beacons from any other deployers. Additionally, the information may include a location identifier (e.g., a 2-byte Major value) that can be utilized to identify the location of the ATM 110, and an ATM identifier (e.g., a 2-byte Minor value) that can be used to identify the actual ATM 110 itself.

After the mobile device 340 extracts the beacon information from the wireless communication channel, the mobile device 340 may communicate with the beacon 315 over the wireless communication channel via the mobile application 345. In some cases, the wireless communication channel may be established to the ATM 110 or a remote server, such as via a wireless communication network provided by a wireless service provider. In some cases, the mobile application 345 may coordinate communication between the mobile device 340 and the beacon 315 automatically, such that the mobile device does not need to be presently operated by the user 105 (e.g., the mobile device may be located in a pocket or bag associated with the user 105).

In response to communication between the mobile device 340 and the beacon 315, the ATM 110 may transition a user interface screen to display an appropriate display window as the user 105 nears the ATM 110. As discussed below, communication between the mobile device 340 and the authentication server 130 may also be triggered in response to the mobile application 345 identifying the beacon 315. Such communication may also cause the user interface screen displayed to the user 105 by the ATM 110 to be modified and/or selected, such as on a positive or negative result of an authentication process. In an illustrative example, if the ATM 110 were displaying first display screen (e.g., a home screen, an advertisement, and the like), the beacon 315 may instruct the ATM 110, via a communication channel to transition from the first display screen to a second display screen (e.g. a welcome screen, an electronic transaction screen, a receipt screen, a secondary authentication request screen and the like). However, in some cases, if a different user nears the same ATM 110 while the first user 105 is approaching, the ATM system 110 may give priority to the user who is closer and/or who first has a picture authenticated by standing in front of the ATM 110.

The method 400 illustrated in FIGS. 3 and 4 shows an illustrative example of user authentication at the ATM 110 of the user 105 to complete a pre-staged transaction begun in the mobile application 345 installed on the mobile device 340 and using Facial Biometrics and a unified identifier including one or more behavioral aspects of the user 105. At 410, a user may log into the mobile application 345 using one or more local authentication methods including, but not limited to, a user identifier and password, a fingerprint scan, a retinal scan, facial recognition, and/or the like. Once logged into the mobile application 345, the user may initiate a transaction via the mobile device 340 to be completed at the ATM 110. For example, the user 105 may pre-stage a transaction for a cash withdrawal at the ATM 110. After pre-staging the transaction, the user 105 may approach the ATM 110 at 420, but not necessarily at the same time as the transaction had been pre-staged. For example, the user 105 may pre-stage the transaction at a first time at a first geographic location and then approach the ATM 110 at a second time at a second location.

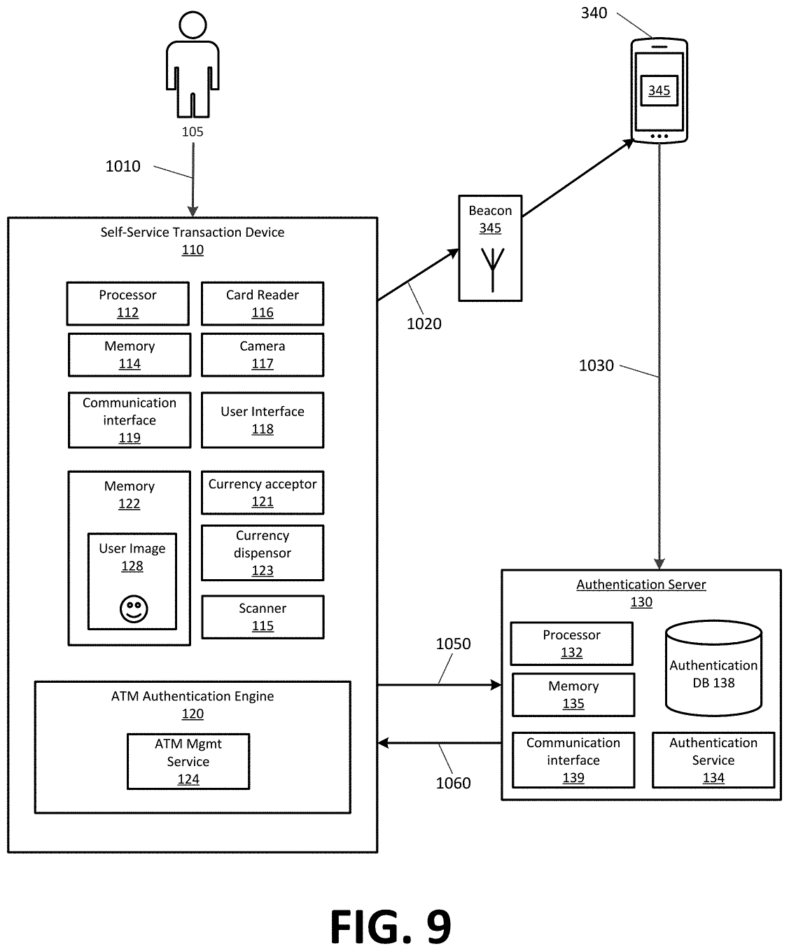

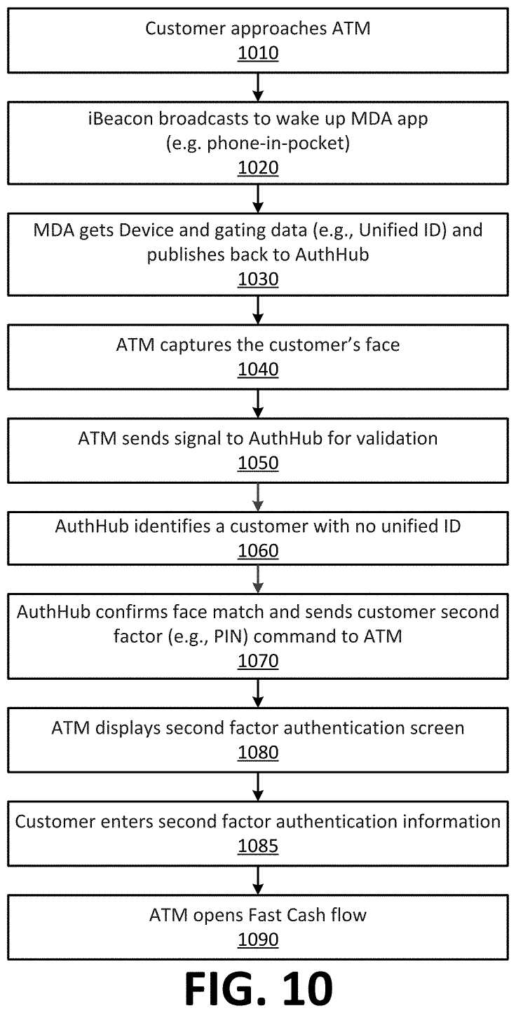

At 430, the beacon 315 may send a broadcast message to “wake up” the mobile application 345. For example, the beacon 315 may periodically send a broadcast message, one of which may be received by the mobile device 340 and be processed by the mobile application 345. The mobile device 340 may or may not be in active use by the user 105, for example, the mobile device 340 may remain in the user's pocket or bag when the beacon's message is received and/or processed. At 440, the mobile application 345 may assemble an authentication message to be sent to the authentication server 130. For example, the mobile application 345 may assemble or receive a message including device and/or gating data (e.g., a unified identifier) which may be then communicated to the authentication server 130. When the user 105 is near the ATM 110, at 450, the ATM 110 may capture an image of the user's face (e.g., the user image 128) and store the image 128 in user memory. The ATM 110 may then send a signal to the authentication server 130 to authenticate the user 105, such as by validating the user image 128 and/or the unified identifier at 460. At 470, the authentication service 134 may compare the image to facial biometric information stored in the data repository 138 and determine a match between the facial biometric information and the unified identifier. If a match is not found with the unified identifier, see FIGS. 9-10 for additional information. If authentication of the facial biometrics and unified identifier was successful, the authentication server 130 may communicate a signal confirming success of the match at 480 and the ATM 110 may dispense cash via the currency dispenser 123 to complete the pre-staged transaction at 490. Advantages of the illustrative example of FIGS. 3 and 4 over existing ATM devices include a mostly hands-free experience, use of a unified identifier as a second factor of authentication and bypasses traditional Base 24 authentication at the ATM 110, with full authorization being handled at the authentication server 130.

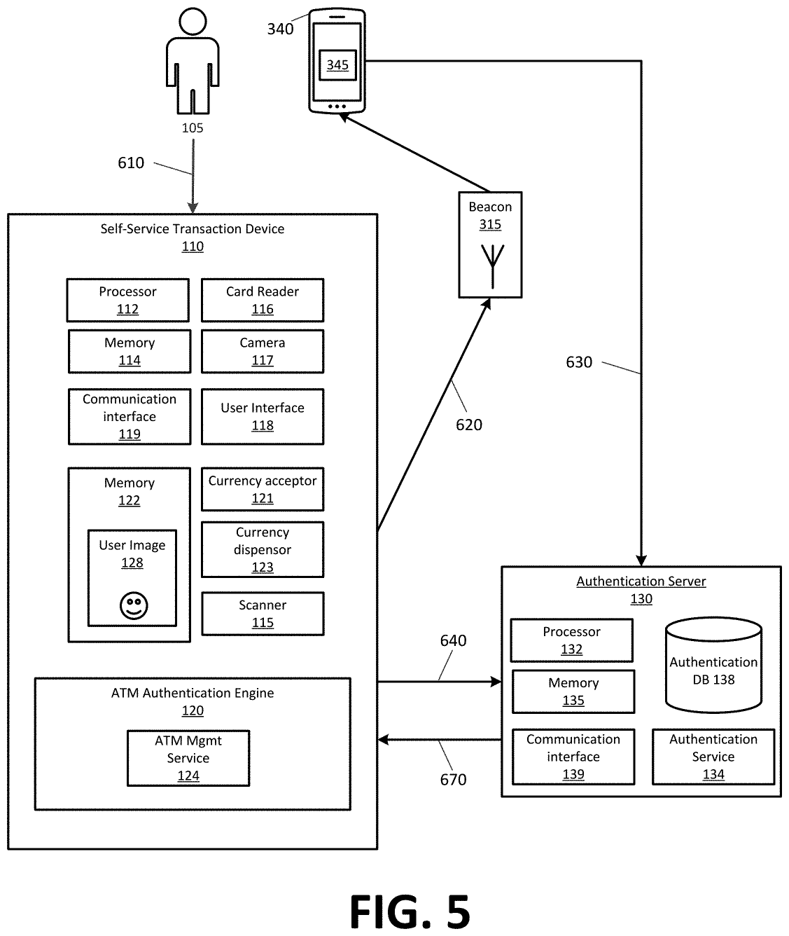

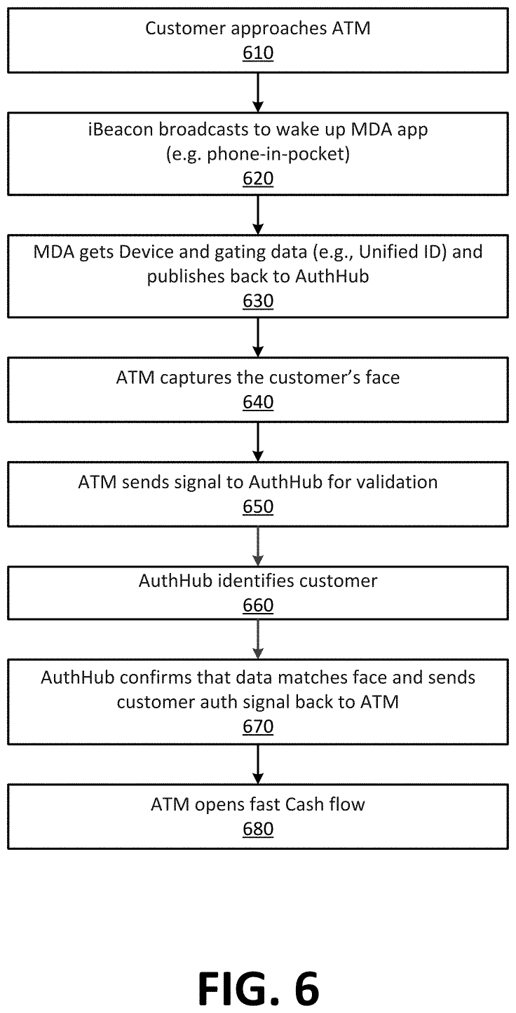

FIGS. 5 and 6 shows an illustrative ATM computing system 500 and method 600 for performing user authentication at the ATM 110 using facial biometrics and a unified identifier that corresponds to behavioral aspects of the user. At 610, the user 105 may approach the ATM 110 with a mobile device 340, where the mobile device 240 may not be in use by the user 105. For example, the mobile device 340 may be in a pocket, bag or otherwise may be unused. At 620, the beacon 315 may send a broadcast message to “wake up” the mobile application 345. For example, the beacon 315 may periodically send a broadcast message, one of which may be received by the mobile device 340 and be processed by the mobile application 345. The mobile device 340 may or may not be in active use by the user 105, for example, the mobile device 340 may remain in the user's pocket or bag when the beacon's message is received and/or processed. At 630, the mobile application 345 may assemble an authentication message to be sent to the authentication server 130. For example, the mobile application 345 may receive a message including device and/or gating data (e.g., a unified identifier) which may be then communicated to the authentication server 130. When the user 105 is near the ATM 110, at 640, the ATM 110 may capture an image of the user's face (e.g., the user image 128) and store the image 128 in user memory. The ATM 110 may then send a signal to the authentication server 130 to authenticate the user 105, such as by validating the user image 128 and/or the unified identifier at 650. At 660, the authentication service 134 may compare the image to facial biometric information stored in the data repository 138 and determine a match between the facial biometric information and the unified identifier. If authentication of the facial biometrics and unified identifier was successful, the authentication server 130 may communicate a signal confirming success of the match at 670 and the ATM 110 may dispense cash via the currency dispenser 123 to complete a desired transaction at 680. Advantages of the illustrative example of FIGS. 3 and 4 over existing ATM devices include a mostly hands-free experience, use of a unified identifier as a second factor of authentication and bypasses traditional Base 24 authentication at the ATM 110, with full authorization being handled at the authentication server 130. Advantages of the illustrative example of FIGS. 5 and 6 over existing ATM devices include a hands-free experience, use of a unified identifier as a second factor of authentication and bypasses traditional Base 24 authentication at the ATM 110, with full authorization being handled at the authentication server 130.

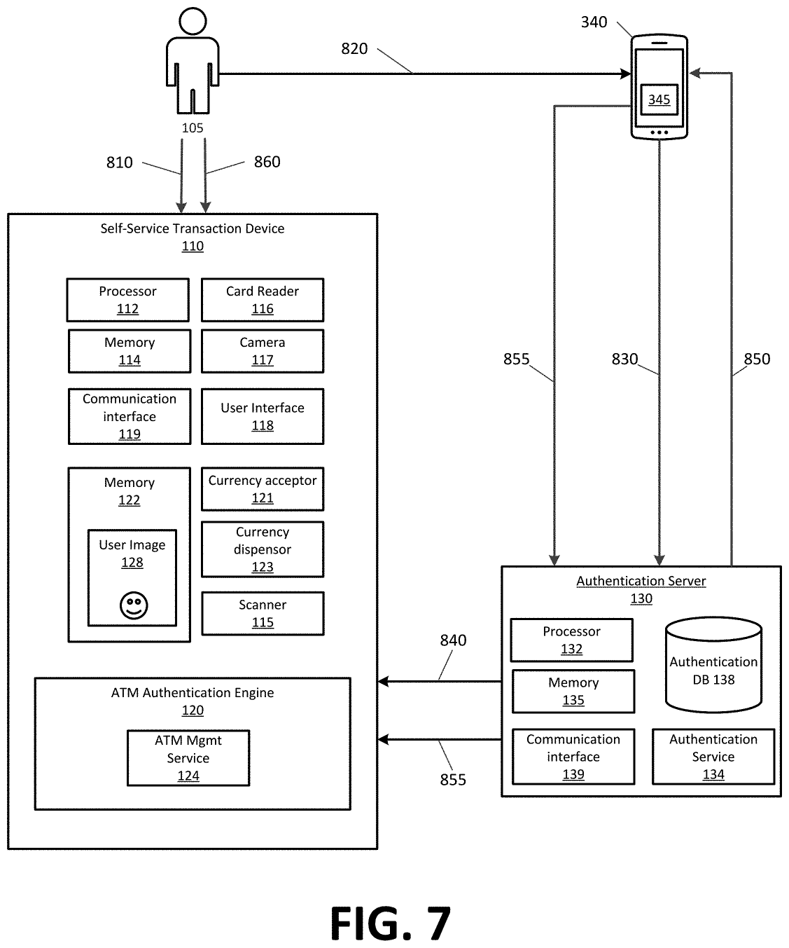

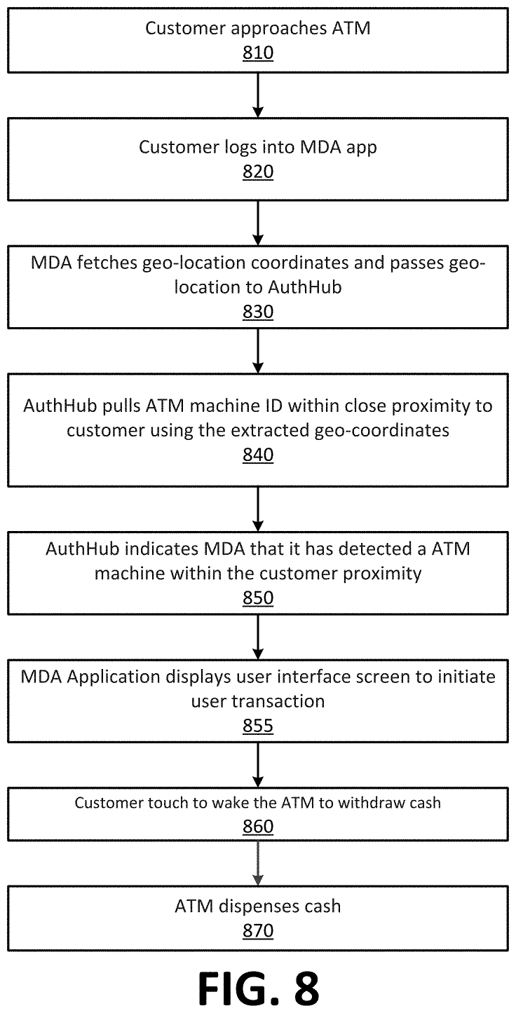

FIGS. 7 and 8 shows an illustrative ATM computing system 700 and method 800 for performing user authentication at the ATM 110 using geographic information and a unified identifier that corresponds to behavioral aspects of the user. In some cases, complete authentication may be performed without use of a card at the ATM 110 and a cash withdrawal may be initiated using a mobile application 345 when the mobile device 340 is near the ATM 110. At 810, the user may approach the ATM and may log into the mobile application 345 on the mobile device at 820. At 830, the mobile application 245 may fetch geolocation information (e.g., geographical coordinates, a street address, and the like) such as from a location sensing device associated with the mobile device (e.g., a global positioning unit or a cellular location unit) and may send the geolocation information to the authentication server 130 via a communication link. At 840, the authentication server 130 may pull an ATM machine identifier, or other identification information, for the ATM 110 in close proximity to the user's extracted geographical coordinates. If two or more ATMs are near the user's location, then the authentication server may pull information from a single ATM, or select one or more of the ATMs and may pull location information from each ATM 110 near the user 105. At 850, the authentication server 130 may then communicate a message to the mobile device 340 that may include an indication that the ATM 110 has been detected in close proximity to the user 105. After receiving the message from the authentication server 130, the mobile device 340 may display a user interface screen prompting the user 105 to begin a transaction, such as by facilitating entry of a currency amount and receiving an input to trigger the transaction at the ATM 110 at 860. The ATM 110 may display a user interface screen to the user 105, as the user reaches the proximity of the ATM 110. At 860, the user 105 may come in physical contact and/or come within a defined proximity of the ATM 110 to cause the ATM 110 to wake to complete the transaction. After the ATM 110 wakes, the ATM 110 may dispense the requested currency via the currency dispenser 123. With such a system and method, no card or PIN authentication is required at the ATM 110. However, if multiple ATMs are within range, an additional form of user identification may be required, such as a fingerprint, retina scan, facial biometric information, and the like. In some cases, to overcome a limitation to remotely wake up the ATM 110, the user 110 may click on an input to trigger an input on the ATM 110 to complete the transaction.

FIGS. 9 and 10 shows an illustrative ATM computing system 900 and method 1000 for performing user authentication at the ATM 110 using facial biometrics and a unified identifier that corresponds to behavioral aspects of the user. At 1010, the user 105 may approach the ATM 110 with a mobile device 340, where the mobile device 240 may not be in use by the user 105. For example, the mobile device 340 may be in a pocket, bag or otherwise may be unused. At 1020, the beacon 315 may send a broadcast message to “wake up” the mobile application 345. For example, the beacon 315 may periodically send a broadcast message, one of which may be received by the mobile device 340 and be processed by the mobile application 345. The mobile device 340 may or may not be in active use by the user 105, for example, the mobile device 340 may remain in the user's pocket or bag when the beacon's message is received and/or processed. At 1030, the mobile application 345 may assemble an authentication message to be sent to the authentication server 130. For example, the mobile application 345 may receive a message including device and/or gating data (e.g., a unified identifier) which may be then communicated to the authentication server 130. When the user 105 is near the ATM 110, at 1040, the ATM 110 may capture an image of the user's face (e.g., the user image 128) and store the image 128 in user memory. The ATM 110 may then send a signal to the authentication server 130 to authenticate the user 105, such as by validating the user image 128 without the unified identifier at 1050. At 1060, the authentication service 134 may compare the image to facial biometric information stored in the data repository 138 and determine a match between the facial biometric information without the unified identifier. If authentication of the facial biometrics was successful, the authentication server 130 may communicate a signal confirming success of the match at 1070 and including a command to the ATM 110 to obtain an additional user identifier, such as a PIN, a fingerprint, a retinal scan, and the like. At 1080, the ATM 110 may display a user interface screen via the user interface 118 and including an input for the user 105 to enter the second factor authentication information, which then may be authenticated at the authentication server and/or locally to the ATM 110, such as by the authentication service 134. At 1090, the ATM 110 may dispense cash via the currency dispenser 123 to complete a desired transaction. Advantages of the illustrative example of FIGS. 9 and 10 over existing ATM devices include a mostly hands-free experience, use of a two-factor identification to bypass traditional Base 24 authentication at the ATM 110, with full authorization being handled at the authentication server 130 or at a combination of the ATM 110 and the authentication server 130.

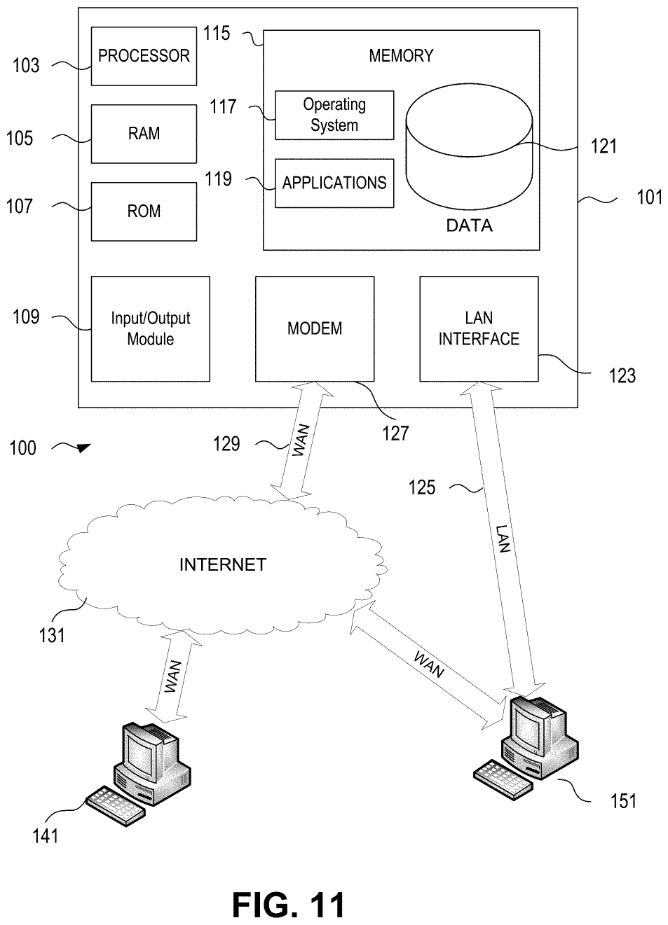

FIG. 11 illustrates a block diagram of a specifically programmed computing device (e.g., a computer server 1101) that may be used according to an illustrative embodiment of the disclosure. The computer server 1101 may have a processor 1103 for controlling overall operation of the server and its associated components, including random access memory device(s) (e.g., RAM 1105), read-only memory device(s) (e.g., ROM 1107), an input/output module 1109, and one or more transitory and/or non-transitory memory devices (e.g., memory 1115).

The Input/Output (I/O) 1109 may include a microphone, keypad, touch screen, camera, and/or stylus through which a user of the computer server 1101 may provide input, and may also include one or more of a speaker for providing audio output and a video display device for providing textual, audiovisual and/or graphical output. Other I/O devices through which a user and/or other device may provide input to the computer server 1101 also may be included. Software may be stored within the memory 1115 and/or storage to provide computer readable instructions to the processor 1103 for enabling the computer server 1101 to perform various technologic functions. For example, the memory 1115 may store software used by the computer server 1101, such as an operating system 1117, an application programs 1119, and/or an associated database 1121. Alternatively, the computer server 1101 may process some, or all, of the computer executable instructions that may be embodied in hardware and/or firmware (not shown). As described in detail above, the database 1121 may provide centralized storage of characteristics associated with vendors and patrons, allowing functional interoperability between different elements located at multiple physical locations.

The computer server 1101 may operate in a networked environment supporting connections to one or more remote computers, such as terminals 1141 and 1151. The terminals 1141 and 1151 may be personal computers or servers that include many or all of the elements described above relative to the computer server 1101. The network connections depicted in FIG. 11 may include a local area network (LAN) 1125 and/or a wide area network (WAN) 1129, and may include other networks. When used in a LAN networking environment, the computer server 1101 is connected to the LAN 1125 through a network interface or adapter 1123. When used in a WAN networking environment, the computer server 1101 may include a modem 1127 or other means for establishing communications over the WAN 1129, such as the Internet 1131. It will be appreciated that the network connections shown are illustrative and other means of establishing a communications link between the computers may be used. The existence of any of various well-known protocols such as TCP/IP, Ethernet, FTP, HTTP and the like is presumed.

The computer server 1101 and/or the terminals 1141 or 1151 may also be mobile terminals including various other components, such as a battery, speaker, and antennas (not shown).

The disclosure is operational with numerous other general purpose or special purpose computing system environments or configurations. Examples of computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, mobile computing devices, e.g., smart phones, wearable computing devices, tablets, distributed computing environments that include any of the above systems or devices, and the like.

The disclosure may be described in the context of computer-executable instructions, such as program modules, being executed by a computer. Generally, program modules include routines, programs, objects, components, data structures, etc. that perform particular tasks or implement particular computer data types. The disclosure may also be practiced in distributed computing environments where tasks are performed by remote processing devices that are linked through a communications network. In a distributed computing environment, program modules may be located in both local and remote computer storage media including memory storage devices.

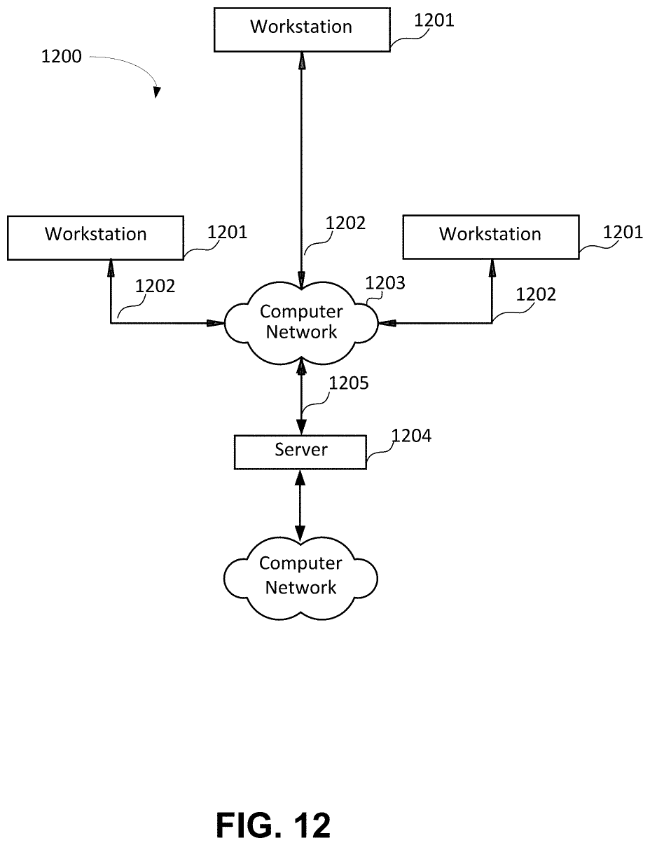

Referring to FIG. 12, an illustrative system 1200 for implementing methods according to the present disclosure is shown. As illustrated, system 1200 may include one or more mobile workstations 1201. The mobile workstations 1201 may be local or remote, and are connected by one or more communications links 1202 to computer networks 1203, 1210 that is linked via communications links 1205 to a server 1204. In the system 1200, the server 1204 may be any suitable server, processor, computer, or data processing device, or combination of the same. The computer network 1203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. The communications links 1202 and 1205 may be any communications links suitable for communicating between the workstations 1201 and the server 2104, such as network links, dial-up links, wireless links, hard-wired links, etc.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computer implemented method, comprising:
receiving, via a local data communications network at a mobile device, a beacon signal including a command to awaken a mobile application on the mobile device;
retrieving, from a memory of the mobile device, a first user identifier associated with the user of the mobile device;
communicating, via a second network, the user first identifier to an authentication server;
capturing, by an automated teller machine (ATM), an image of the user of the mobile device;
communicating, the image of the user to the authentication server;
receiving, at the ATM, a signal including an authentication indication corresponding to the image and a unified user identifier; and
dispensing, by a currency dispenser of the ATM, a specified amount of currency after receipt of the authentication indication and the unified user identifier.

2. The computer implemented method of claim 1, comprising:
broadcasting, by a beacon device, a beacon signal including an activation command; and
communicating, by the beacon device, an ATM identifier of the ATM associated with the beacon device.

3. The computer implemented method of claim 2, wherein the beacon device is in proximity to the ATM.

4. The computer implemented method of claim 2, wherein the beacon device is adjacent to a component of the ATM.

5. The computer implemented method of claim 2, wherein the ATM identifier includes a geographic location of the ATM.

6. The computer implemented method of claim 1, wherein waking the mobile application occurs automatically after receipt of the beacon signal at the mobile device.

7. The computer implemented method of claim 1, comprising:
displaying, on a user interface of the ATM, a user interface screen prompting the user to enter an amount of currency via an input device of the ATM.

8. The computer implemented method of claim 1, wherein the unified user identifier comprises one or more behavioral characteristics of the user.

9. The computer implemented method of claim 8, wherein the one or more behavioral characteristics of the user includes at least one of a swiping pattern, gait information, and login information.

10. An automated teller machine (ATM) computing system, comprising:
an ATM comprising a processor and a non-transitory memory device storing instructions that, when executed by the processor, cause the ATM to:
receive, at a communication interface, a signal indicating that a user is approaching the ATM;
capture, by an imaging device, an image of the user;
communicating, via a network connection, the image to an authentication server;
receiving, via the network connection, an authorization signal from the authentication server comprising an authentication indication for the image and a unified user identifier; and
dispensing, by a currency dispenser of the ATM, a specified amount of currency upon authentication of the additional authentication information.

11. An ATM computing system of claim 10, comprising:
a mobile device associated with the user, the mobile device including a mobile application; and
a beacon device associated with the ATM broadcasting a beacon signal including an activation command and an ATM identifier of the ATM.

12. The ATM computing system of claim 11, wherein the beacon device is in proximity to the ATM.

13. The ATM computing system of claim 11, wherein the beacon device is adjacent to a component of the ATM.

14. The ATM computing system of claim 11, wherein the ATM identifier includes a geographic location of the ATM.

15. The ATM computing system of claim 11, wherein upon receipt of the beacon signal at the mobile device, the mobile application is automatically awakened.

16. The ATM computing system of claim 10, wherein the instructions further cause the ATM to:
display on a user interface of the ATM, a user interface screen requesting that the user enter a desired amount of currency; and
receive, via an input device of the ATM, the specified amount of currency.

17. The ATM computing system of claim 10, wherein the unified user identifier comprises user behavioral information.

18. The ATM computing system of claim 17, wherein the user behavioral information comprises a swiping pattern.

19. The ATM computing system of claim 17, wherein the user behavioral information comprises user gait information.
